(19) United States
(12) Patent Application Publication
(10) Pub. No.: US 2002/0006245 A1
(43) Pub. Date: Jan. 17, 2002

(54) Optical circuit

(76) Inventors: Yoshinobu Kubota, Plano, TX (US); Takehito Tanaka, Kawasaki (JP)

Correspondence Address: STAAS & HALSEY LLP, 700 11TH STREET, NW, SUITE 500, WASHINGTON, DC, 20001, US

(21) Appl. No.: 09/761,778

(22) Filed: Jan. 18, 2001

(30) Foreign Application Priority Data
Jul. 11, 2000 (JP) 2000-209725

(51) Int. Cl. G02B 6/12

(52) U.S. Cl. 385/14

(57) ABSTRACT

The present invention relates to an optical circuit having a plurality of optical elements formed therein, and in particular, an optical circuit provided with optical waveguides that guide subsidiary light from an optical element. The optical circuit according to the invention is provided in a substrate 11 having a plurality of optical elements formed therein, with the first optical waveguide 13 that guides light to be outputted from at least one of a plurality of optical elements 12, and a second optical waveguide 14 that guides light emitted and leaking from the first optical waveguide 13.

### BACKGROUND OF THE INVENTION

1. Field of the Invention

The present invention relates to an optical circuit having a plurality of optical elements formed on a substrate, and in particular, an optical circuit provided with an optical waveguide for guiding light emitted or leaking from optical elements.

Recently, in the field of transmission technology, optical communication technology that realizes super long-haul transmission and high bit-rate transmission have been vigorously researched so as to adapt to a remarkable increase in the traffic amount due to the expansion of the Internet.

2. Description of the Related Art

In the optical communication technology, various optical elements such as a lens, an optical coupler, an optical multiplexer, a demultiplexer, an optical switch, an optical attenuator, an optical modulator, a semiconductor laser source, and an optical filter are utilized. The optical elements perform certain control over a state of light inputted from an optical input port and outputs the controlled light through an optical output port. The states of light to be controlled signifies phase, light intensity, wavelength, and polarization.

At present, in an attempt to stabilize a system and reduce production costs, integration of various types of optical elements has been researched. There is an optical integrated circuit such as a waveguide type optical circuit (PLC, Planar Lightwave Circuit), etc. as an integration technology.

On the other hand, another optical modulator is a Mach-Zehnder interferometer type optical modulator (hereinafter called an “MZ type optical modulator”). The MZ type optical modulator is constructed so that one optical waveguide is dropped into two by an optical dropping device at the intermediate portion thereof and is coupled as one unit by an optical coupler. And, the MZ type optical modulator differentiates an optical distance by applying a voltage to the respective optical waveguide at the intermediate portion thereof. In the MZ type optical modulator, the operating point of the applied voltage shifts due to chronological changes resulting from a temperature drift, a DC drift, and stress, etc. For example, in Japanese Unexamined Patent Application publication Nos. Hei10-228006 and Hei10-221664, as one of the countermeasures, the operating point is controlled by monitoring light emitted or leaking from an optical waveguide that guides a main optical signal.

However, in an optical integrated circuit, a part of main light to be controlled sometimes leaks from an optical waveguide for guiding the main light. A portion of the optical coupler is designed so that the optical waveguide can guide light only in a predetermined mode, therefore, light in modes other than the predetermined mode may be emitted. There causes a problem by which such emitted light or leaked light flows in a substrate and enters into an optical waveguide in the other optical elements as noise.

In particular, in an MZ type optical modulator where the operating point is controlled by monitoring emitted or leaking light, subsidiary light emitted or leaking from the optical coupling part of the MZ type optical modulator is mixed with subsidiary light emitted or leaking from an optical coupling part in the other optical coupler or other optical element, which leads to another problem of having a difficulty in properly controlling the operating point.

### SUMMARY OF THE INVENTION

It is therefore an object of the invention to provide an optical circuit capable of releasing subsidiary light emitted or leaking from a certain optical element in order not to influence the other optical elements.

An optical circuit according to the invention includes a substrate having a plurality of optical elements formed therein, a first optical waveguide formed on the substrate for guiding to be output from the optical elements (hereinafter called “main light”), and a second optical waveguide formed on the substrate for guiding light emitted or leaking from the first optical waveguide (hereinafter called “subsidiary light”).

Herein, at least one of the plurality of optical elements is, for example, of Mach-Zehnder type.

At least one of the plurality of optical elements is, for example, a Mach-Zehnder interferometer type optical modulator.

At least two of the plurality of optical elements are, for example, connected in tandem.

In addition, the substrate is made of a ferroelectric material, for example.

Further, two of the plurality of optical elements are a first Mach-Zehnder type optical modulating part for applying a clock signal voltage at a predetermined cycle to an electrode for varying the refractive index of an optical waveguide for guiding the main light, and a Mach-Zehnder type optical modulating part connected in tandem with the first Mach-Zehnder type optical modulating part for applying a signal voltage modulated based on information to be transmitted, to the electrode.

The substrate is made of a lithium niobate (LiNbO₃), for example.

In addition, the main light is inputted into the first Mach-Zehnder type optical modulating part for attenuating the light intensity and changes the amount of attenuation via the variable optical attenuating part.

As described above, in the case where a plurality of optical elements is formed on the same substrate, it is possible to release leaking light and emissive light in order not to influence the other optical elements since in the optical circuit according to the invention, an optical waveguide exclusive for releasing the lights emitted and leaking from a certain optical element is formed.

In particular, in a case where the other optical elements control their operation such as control over the operating point shifting by utilizing leaking light or emissive light, the operations can be controlled with reliability since the optical waveguide according to the invention prevents unnecessary light from being mixed with or interfering with leaking light or emissive light.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIGS. 1 are views each showing the principle configuration of the invention;

FIGS. 2 are views each showing the construction of an optical modulator according to an embodiment of the invention;

FIGS. 3 are cross-sectional views each showing respective sections of an optical modulator according to the embodiment;

FIGS. 4 are views each explaining the main signal light and emissive light in an MZ type optical waveguide;

FIG. 5 is a view showing the relationship between the input/output characteristics and the operating point shifting of the MZ type optical modulating part;

FIGS. 6 are views each showing a producing process of an optical waveguide in an optical modulator according to the embodiment;

FIGS. 7 are a view showing the entire construction of an optical waveguide according to the invention and partially enlarged views showing a part from the Y-shaped coupling part R2 to the Y-shaped dropping part R1; and

FIGS. 8 are views each showing an example of other patterns of the optical waveguide according to the invention.

### DESCRIPTION OF THE PREFERRED EMBODIMENTS

### Principle Construction of the Invention

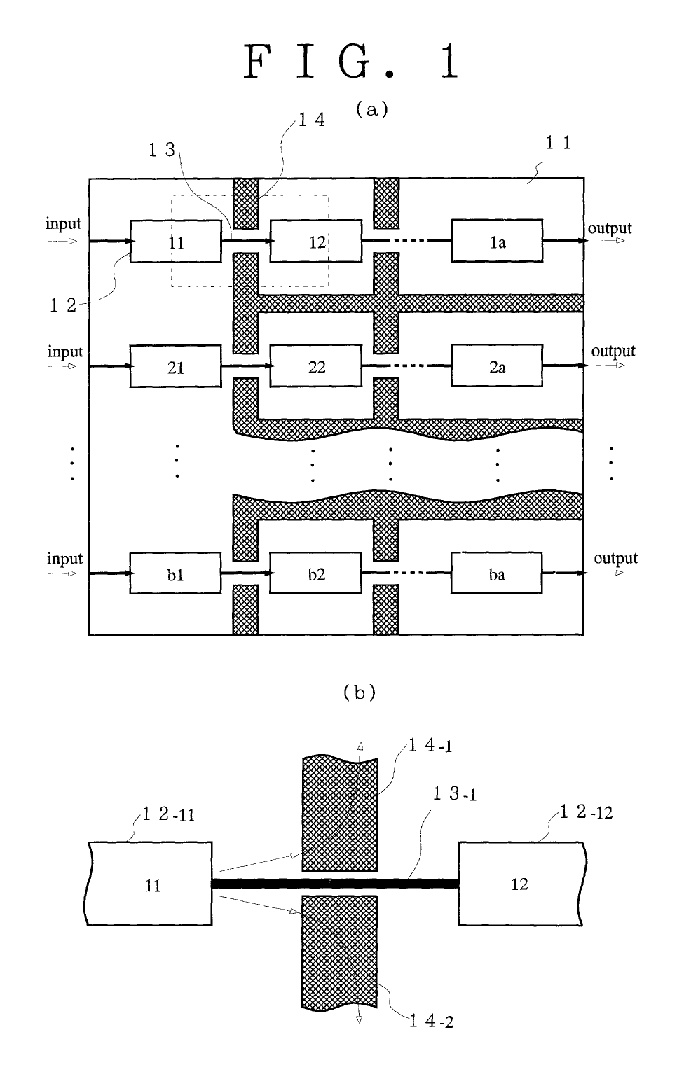

FIGS. 1 are views each showing the principle construction of the invention, wherein FIG. 1(a) is a view showing the entire construction thereof, and FIG. 1(b) is a partially enlarged view showing a part “a” surrounded by broken lines in FIG. 1(a).

In FIGS. 1, a substrate 11 having a plurality of optical elements 12 formed thereon is provided with the first optical waveguide 13 and the second optical waveguide 14.

The first optical waveguide 13 is constructed so as to guide light (hereinafter called “main light”) to be outputted from at least one of the plurality of optical elements.

On the other hand, the second optical waveguide 14 is constructed so as to guide light (hereinafter called “subsidiary light”) emitted or leaking from the first optical waveguide 13.

In FIGS. 1, solid lines denominate the first optical waveguide 13 that guides the main light for which the state of light is controlled by the optical element 12, and dotted sections denominate the second optical waveguide 14 that guides subsidiary light such as emissive light and leaking light, which excludes the main light.

In such an optical circuit, the subsidiary light outputted from a certain optical element is released by the second optical waveguide 14 so as not to enter into other optical elements 12. For example, the subsidiary light is guided to the outside of the substrate 11. Therefore, the subsidiary light does not interfere with the main light in the other optical elements 12 as noise, which improves the optical signal-to-noise ratio.

In such an optical circuit, it can be devised that subsidiary light outputted from a certain optical element 12 is not mixed with subsidiary light outputted from the other optical element 12. Therefore, the subsidiary light outputted from a certain optical element 12 does not interfere with the subsidiary light in the other optical element 12. Accordingly, in the case where the other optical element 12 is constructed such that its operating state is controlled by subsidiary light outputted from itself, secure control can be executed.

Herein, it is preferable that one end of the second optical waveguide 14 for guiding the subsidiary light is constructed so as to reach the end of the outside face of the substrate 11 and the surface of the substrate (at least one of the upper surface and the lower surface) and to release the subsidiary light to the exterior. Further, in view of releasing the subsidiary light with reliability, it is preferable to form a reflection mirror or a diffraction grating to reflect, on the surface opposite to the one releasing the subsidiary light.

With reference to a part between the optical element 12-11 and optical element 12-12 in FIG. 1(b), a detailed description will be given below

The main light whose optical state is controlled by the optical element 12-11 is guided via the first optical waveguide 13-1 to be inputted into the optical element 12-12. On the other hand, the subsidiary light outputted from the optical element 12-11 is inputted into the second optical waveguide 14-1 formed between the optical element 12-11 and the optical element 12-12, and is led out by the second optical waveguides 14-1 and 14-2. Therefore, the subsidiary light can be released so as not to reach the optical element 12-12.

### Embodiment of the Invention

Next, a description will be given of an embodiment of the invention with reference to the accompanying drawings. In respective drawings, parts and constructions that are identical to those in the other drawings are given the same reference numbers, and overlapping description is omitted.

### Construction of the Embodiment

The present embodiment refers to an optical modulator according to the invention.

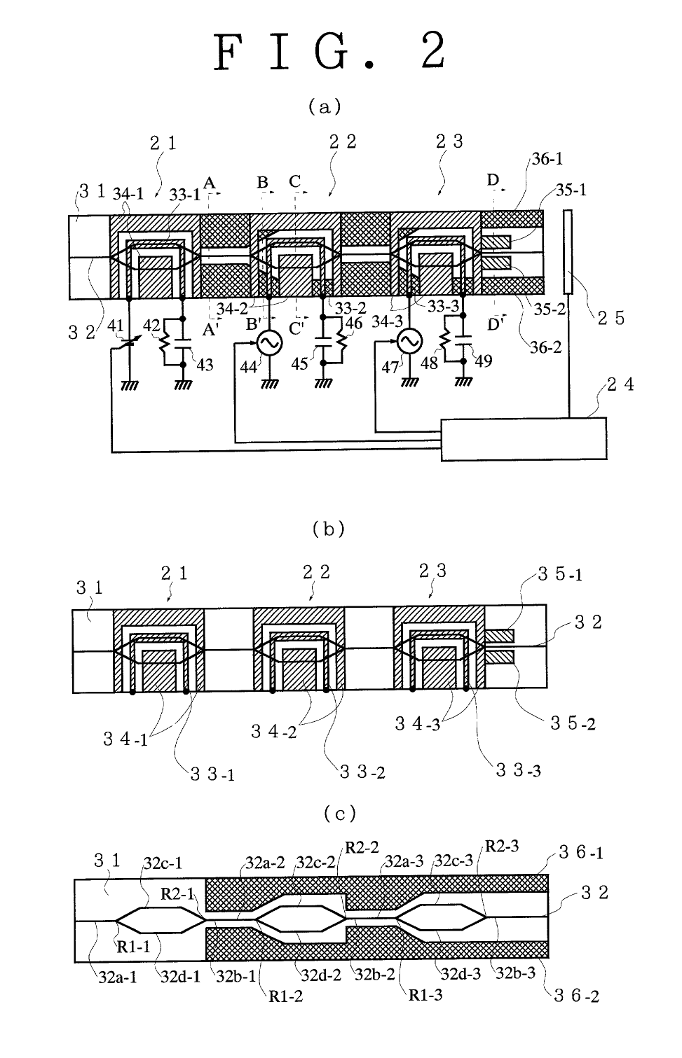

FIGS. 2 show a construction of an optical modulator according to the embodiment.

Also, FIG. 2(a) shows the entire construction of the embodiment, FIG. 2(b) is the portion of a substrate from which the second optical waveguide that guides subsidiary light signals is excluded, and FIG. 2(c) shows the portion of a substrate of the first optical waveguide that guides the main light signals and the second optical waveguide that guides subsidiary light signals.

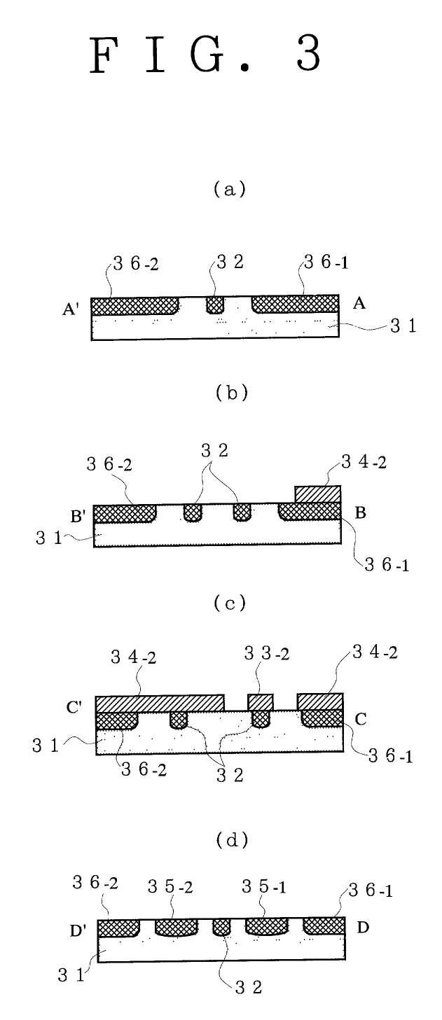

FIGS. 3 show respective sections of the optical modulator according to the embodiment.

In addition, FIG. 3(a) shows the cross section taken along the line A-A′ in FIG. 2(a), FIG. 3(b) shows the cross section taken along the line B-B′ in FIG. 2(a), FIG. 3(c) shows the cross section taken along the line C-C′ in FIG. 2(a), and FIG. 3(d) shows the cross section taken along the line D-D′ in FIG. 2(a).

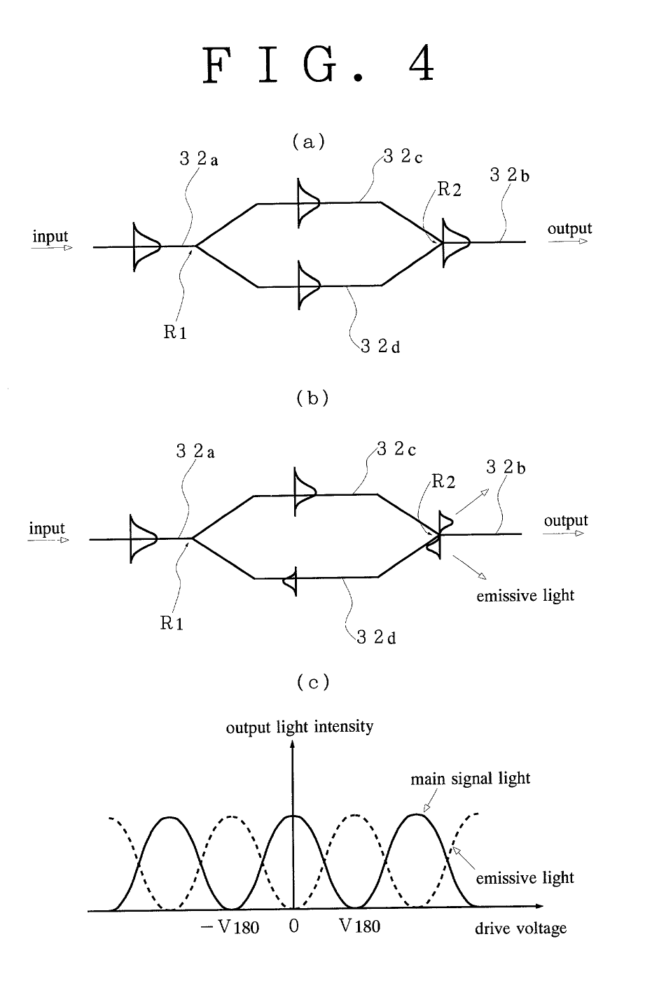

FIGS. 4 are views explaining the main light signals and emissive light in a Mach-Zehnder type optical waveguide.

In FIGS. 2 and FIGS. 4, an optical modulator according to the embodiment is such that an optical waveguide 32 that guides main light signals is formed on a lithium niobate (Z plate) substrate 31. The optical waveguide 32 is formed to be an MZ type at three points in the intermediate portion. The MZ type optical waveguide 32 includes an input optical waveguide 32a, an output optical waveguide 32b and intermediate optical waveguides 32c and 32d at respective points as shown in FIGS. 4. The intermediate portions 32c and 32d are connected to each other in parallel via a Y-shaped dropping part R1 and a Y-shaped coupling part R2 between the input optical waveguide 32a and the output optical waveguide 32b.

A travelling-wave electrode 33 is formed on the upper part of one of the intermediate optical waveguides 32c and 32d, and a ground electrode 34 is formed on the upper part of the other.

In an MZ type optical element formed at the three points, the first point from the input side is assigned to the variable optical attenuating part 21, the second point is assigned to the first optical modulating part 22, and the third point is assigned to the second optical modulating part 23.

One end of the travelling-wave electrode 33-1 in the variable optical attenuating part 21 is grounded via a variable voltage source 41, and the other end thereof is grounded via a resistor 42 and a capacitor 43 that are connected thereto in parallel.

One end of the travelling-wave electrode 33-2 in the first optical modulating part 22 is grounded via a signal source 44 that supplies clock signals, and the other end thereof is grounded via a resistor 46 and a capacitor 45 that are connected thereto in parallel.

One end of the travelling-wave electrode 33-3 in the second optical modulating part 23 is grounded via a signal source 47 that supplies signals modulated according to information to be transmitted, and the other end thereof is grounded via a resistor 48 and a capacitor 49 that are connected thereto in parallel.

These variable voltage source 41 and signal sources 44 and 47 are respectively controlled by the signal control circuit 24.

Grounding electrodes 34-1, 34-2, and 34-3 at the respective parts are respectively grounded (not illustrated).

Optical waveguides 35-1 and 35-2 whose upper surface is made almost rectangular are formed in the substrate 31 so that one side of the respective rectangles becomes parallel to both sides of the output optical waveguide 32b-3 in the second optical modulating part, and the optical waveguides 35-1 and 35-2 guide leaking light and emissive light from the Y-shaped coupling part R2-3 in the second optical modulating part 23.

As disclosed in Japanese Unexamined Patent Application Publication Nos. Hei10-228006 and Hei10-221664, the optical waveguides 35-1 and 35-2 are formed so that the upper surface thereof is made almost rectangular or trapezoidal so as to become narrower toward the end face of the substrate 31.

Leaking light and emissive light guided by the optical waveguides 35-1 and 35-2 are inputted into an optical receiving part 25 utilizing a photoelectric effect to detect the light intensity. It is possible to use, for example, a photo diode as the optical receiving part 25. The detected output is inputted into the signal control circuit 24. The signal control circuit 24 optimizes the operating point of the second optical modulating part 23 on the basis of the output of the optical receiving part 25.

On the other hand, as shown in FIG. 2(b) and FIG. 2(c), optical waveguides 36-1 and 36-2 that guide subsidiary light signals are formed in the substrate 31. The optical waveguides 36-1 and 36-2 are formed at both sides of the output optical waveguide 32b-1 of the variable optical attenuating part 21 and the input optical waveguide 32a-2 of the first optical modulating part 22 so as to become almost parallel thereto backward of the Y-shaped coupling part R2-1 in the variable optical attenuating part 21 between the variable optical attenuating part 21 and the first optical modulating part 22. The cross-section thereof is as shown in FIG. 3(a). In the first optical modulating part 22, the optical waveguides 36-1 and 36-2 are formed so as to become roughly parallel to the Y-shaped dropping part R1-2 and the intermediate optical waveguides 32c-2 and 32d-2 of the first optical modulating part 22, and are extended to the Y-shaped coupling part R2-2. The cross-section thereof is as shown in FIG. 3(b) and FIG. 3(c). The optical waveguides 36-1 and 36-2 are formed so as to become roughly parallel to the output optical waveguide 32b-2 of the first optical modulating part 22 and the input optical waveguide 32a-3 of the second optical modulating part 22 between the first optical modulating part 22 and the first optical modulating part 23. Further, in the second optical modulating part 23, the optical waveguides 36-1 and 36-2 are formed so as to become roughly parallel to the Y-shaped dropping part R1-3 and the intermediate optical waveguides 32c-3 and 32d-3 of the second optical modulating part 23, and are extended to the output end face of the substrate 31. The cross-section is as shown in FIG. 3(d).

In addition, the interval between the optical waveguide 32 and the optical waveguides 36-1 or 36-2 is designed so as to sufficiently prevent these optical waveguides from being coupled to each other.

Herein, the subsidiary light signals mainly include leaking light and emissive light. However, a description will be given of the emissive light.

In FIGS. 4, (a) shows a state of light propagation where no voltage is applied to the travelling-wave electrode (where the travelling-wave electrode has the same potential as that of the ground electrode), (b) shows a state of light propagation where voltage is applied to the travelling-wave electrode, and (c) shows the relationship between the main signal light and emissive light. Also, in FIGS. 4(a) and 4(b), propagation modes of the input optical waveguide 32a, output optical waveguide 32b and intermediate optical waveguides 32c and 32d are shown in the form of waves. The optical waveguide 32 is designed so as to propagate light in a predetermined mode only. The abscissa of FIG. 4(c) indicates drive voltage, and the ordinate thereof indicates the output light intensity.

In FIG. 4(a), when input light in a predetermined mode is inputted into an MZ type input optical waveguide 32a, it is dropped in the Y-shaped dropping part R1 to be inputted into the intermediate optical waveguides 32c and 32d. After the light propagates in the intermediate optical waveguides 32c and 32d in the same mode as the input mode, the lights are combined in the Y-shaped coupling part R2 to be outputted to the output optical waveguide 32b. The combined light propagates through the output optical waveguide 32b since it enters the same mode as the input mode.

In FIG. 4(b), on the other hand, when the input light in a predetermined mode is inputted into the MZ type input optical waveguide 32a, it is dropped in the Y-shaped dropping part R1 to be inputted into the intermediate optical waveguides 32c and 32d. However, in this case, since voltage is applied to the travelling-wave electrode, the refractive index of the intermediate optical waveguides 32c and 32d changes and then the light propagation rate changes. This results in differentiating in phase light propagating in the intermediate optical waveguides 32c and 32d and combining the lights of different phases from each other in the Y-shaped coupling part R2 to be outputted to the output optical waveguide 32b. The combined light is placed into a mode different from the input mode due to the phase differences thereof. This makes it impossible to propagate the light in the output optical waveguide 32b and consequently the light is emitted inside the substrate 31 as emissive light.

Therefore, as shown in FIG. 4(c), the main light signal (solid line) x and emissive light (broken line) y having a relationship in which the respective phases are inverted.

The first optical modulating part 22 and the second optical modulating part 23 have a photoelectric effect by a voltage applied onto the electrode and change the refractive index, the variable optical attenuating part 21 have a thermooptic effect due to a voltage applied onto the electrode and changes the refractive index.

The leaking light slightly leaks from the main signal light in the substrate 31 in such an optical waveguide 32, and it mainly leaks through the Y-shaped coupling part R2.

A description will be given of the operating point shifting of the second optical modulating part 23.

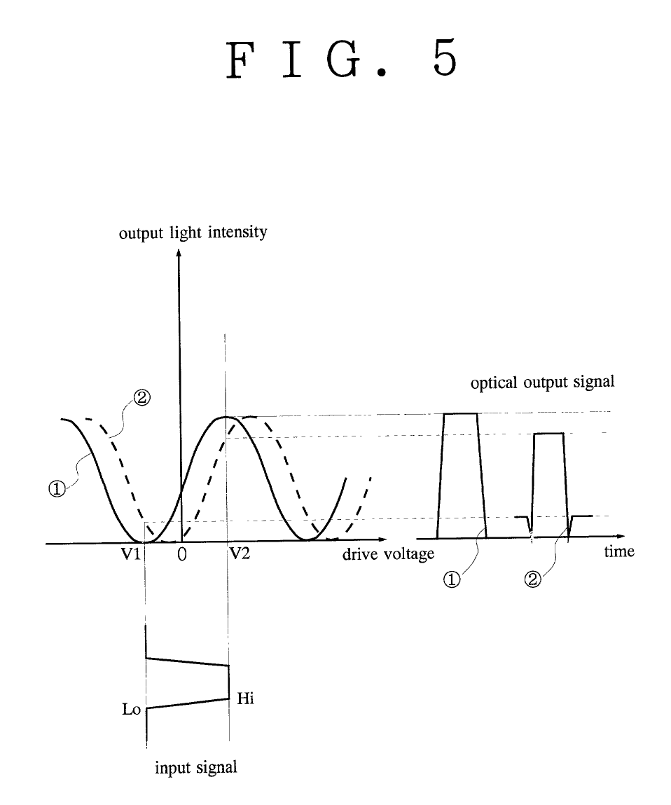

FIG. 5 shows the relationship between the input/output characteristics of a Mach-Zehnder type optical modulating part and the operating point shifting.

In FIG. 5, “A” shows the characteristics before the operating point shifts, and “B” shows the characteristics in a case where the operating point has shifted.

As shown in FIG. 5, the output light intensity cyclically changes with respect to changes in the drive voltage in the MZ type second optical modulating part 23.

Therefore, binary modulation can be performed by applying drive voltages V1 and V2 at which respective upper and lower cuspidal values of the output light intensity can be obtained, corresponding to the logic values (Lo and Hi) of an input signal.

Herein, if the drive voltages V1 and V2 are fixed in a case where the operating point has shifted as shown by broken lines in the optical quenching ratio, the output of the optical signal outputted from the second optical modulating part 23 is degraded by a shift amount of the voltage dV, as shown in FIG. 5, due to the cyclicity of the input and output characteristics. Therefore, when the operating point has shifted, the operating point may be controlled by setting the drive voltages V1 and V2 to (V1+dV) and (V2+dV), respectively.

As described above, since the main light signal and emissive light have their phases inverted from each other, the emission light have information of the main light signal including the operating point shifting as shown in FIG. 4(c). Therefore, as shown in FIG. 2, the optical receiving part 25 monitors the leaking light and emissive light from the Y-shaped coupling part R2-3 of the second optical modulating part 23 so that it is possible for the signal control circuit 24 to control the operating point.

### Process of Producing an Optical Modulator

Next, a description will be given of the production process of an optical modulator according to the embodiment.

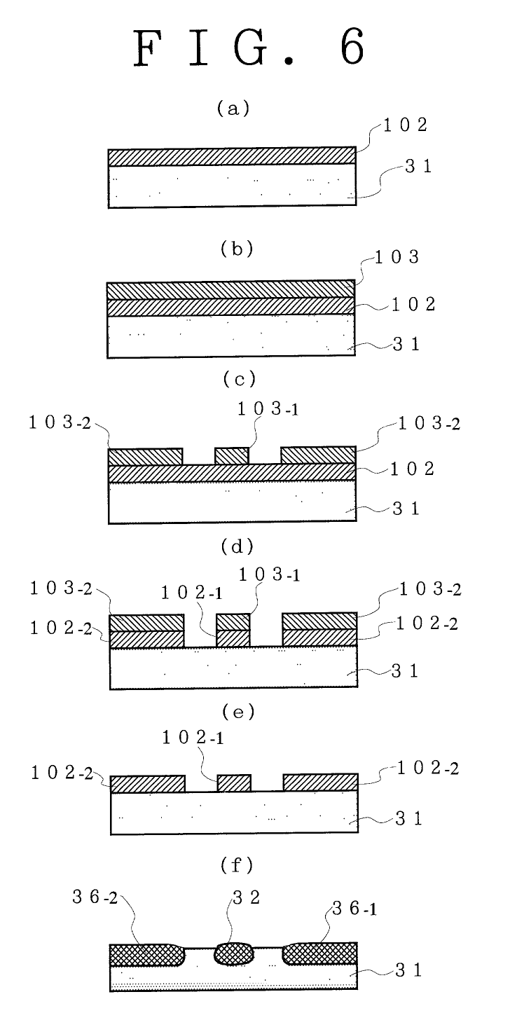

FIG. 6 shows a process of producing an optical waveguide in an optical modulator according to the embodiment.

In addition, FIGS. 6 correspond to the substrate 31 and optical waveguides 32 and 36 on the cross section taken along the line A-A′ in FIG. 2(a).

First, a substrate 31 made of lithium niobate (Z plate) being a ferroelectric material is prepared, and titanium 102 is accumulated on the surface of the substrate 31 like a film at a thickness of 1000 angstroms according to a vacuum evaporation method (FIG. 6(a)).

Next, a photoresist 103 is coated on the surface of a film-like titanium 102 (FIG. 6(b)), and the photoresist 103 is removed except a portion to become an optical waveguide (FIG. 6(c)).

Next, unnecessary titanium 102 is removed by etching (FIG. 6(d)), and the photoresist 103 is removed (FIG. 6(e)).

According to standard photolithography and microtreatment, patterning is performed (FIG. 6(e)) so that titanium 102-1 remains on the surface of the substrate 31 corresponding to the portion to become an optical waveguide 32 that guides main light signals, so that titanium 102-2 remains on the surface of the substrate 31 corresponding to the portion to become an optical waveguide 36 that guides leaking light and emissive light, and so that titanium remains on the surface of the substrate 31 corresponding to the portion to become an optical waveguide 35 that guides the leaking light and emissive light for controlling the operating point shifting (not illustrated in FIGS. 6).

Next, the titanium 102 is diffused on the substrate 31 by a titanium diffusion process in which titanium is placed in high-temperature (1050° C.) oxygen (wet O₂) for approximately ten hours, wherein an area having a refractive index greater than that of lithium niobate is formed to form optical waveguides 32, 35, and 36. (FIG.6 (f), wherein the optical waveguide 35 is not illustrated).

In such a production process, it is advantageous that all the optical waveguides 32, 35, and 36 can be produced in the same process.

Next, a metal to be used for an electrode, such as aluminum (Al) and gold (Au), is vacuum-evaporated to be patterned according to the standard photolithography and micro-treatment, thereby forming a travelling-wave electrode and a ground electrode.

In addition, in view of reducing the absorption of the main light signals by the travelling-wave electrode and ground electrode, it is favorable that a thin film layer such as silicon dioxide (SiO2) is formed between the optical waveguides and the travelling-wave electrode or ground electrodes.

### Actions and Effects of the Embodiment

Laser light outputted from a semiconductor laser, etc., is inputted into an input optical waveguide 32a-1 of a variable optical attenuating part 21. In the variable optical attenuating part 21, the inputted laser light is dropped by the Y-shaped optical dropping part R1-1 to propagate in intermediate optical waveguides 32c-1 and 32d-1, and it is combined in the Y-shaped coupling part R2-1. At this time, heat is added to the intermediate optical waveguide 32c-1 in accordance with a voltage applied to the travelling-wave electrode 33-1 so that the intermediate optical waveguides 32c-1 a and 32d-1 have a different temperature from each other. This causes a difference in the optical distance between the intermediate optical waveguides 32c-1 and 32d-1 in accordance with the temperature difference, and the light intensity of the laser light outputted from the output optical waveguide 32b-1 is attenuated at a predetermined attenuation rate. The rate of attenuation is controlled by the signal control circuit 24.

Even if leaking light and emissive light is generated when combining the laser light by the Y-shaped coupling part R2-1 of the variable attenuating part 21, the leaking light and emissive light are inputted into the optical waveguides 36-1 and 36-2 provided at both sides of the output optical waveguide 32b-1 to be led out to the outside of the substrate 31. Therefore, the leaking light and emissive light from the variable optical attenuating part 21 will not enter into or interfere with the first optical modulating part 22.

The laser light adjusted at a predetermined light intensity is propagated from the output optical waveguide 32b-1 of the variable optical attenuating part 21 to the input optical waveguide 32a-2 of the first optical modulating part 22. In the first optical modulating part 22, the laser light is dropped by the Y-shaped dropping part R1-2, and is propagated in the intermediate optical waveguides 32c-2 and 32d-2, respectively. The laser light is combined by the Y-shaped coupling part R2-2. At this time, the refractive index changes in the intermediate optical waveguide 32c-2 due to a photoelectric effect in accordance with a voltage applied to the travelling-wave electrode 33-1 so that the laser light propagating in the respective intermediate optical waveguides 32c-2 and 32d-2 are differentiated in phase. Since the applied voltage changes with clocks of a predetermined cycle, the laser light is turned on and off at the clock cycle.

As described with reference to FIGS. 4, even if leaking light and emissive light are generated in the Y-shaped coupling part R2-2 of the first optical modulating part 22, the leaking light and emissive light are inputted into the optical waveguides 36-1 and 36-2 provided at both sides of the output optical waveguide 32b-2 and are led out to the outside of the substrate 31. Therefore, the leaking light and emissive light from the first optical modulating part 22 will not enter into and interfere with the second optical modulating part 23.

The laser light modulated at a predetermined clock cycle is propagated from the output optical waveguide 32b-2 of the first optical modulating part 22 to the input optical waveguide 32a-3 of the second optical modulating part 23. In the second optical modulating part 22, the laser light is dropped by the Y-shaped dropping part R1-3, is propagated in the intermediate optical waveguides 32c-3 and 32d-3, respectively, and it is combined by the Y-shaped coupling part R2-3. At this time, a refractive index changes due to a photoelectric effect in the intermediate optical waveguide 32c-3 in accordance with the voltage applied to the travelling-wave electrode 33-2, the laser light propagating in the respective optical waveguides 32c-3 and 32d-3 is differentiated in phase. Since the applied voltage is modulated in accordance with information to be transmitted, the laser light is turned on and off in accordance with the modulation.

In the Y-shaped coupling part R2-3 of the second optical modulating part 23, leaking light and emissive light are inputted into the optical waveguides 35-1 and 35-2 provided at both sides of the output optical waveguides 32b-3. The leaking light and emissive light are inputted into the optical receiving part 25 from the side of the substrate 31 to be utilized to control the operating point of the second optical modulating part 23. In this case, since the leaking light and emissive light from the variable optical attenuating part 21 and the first optical modulating part 22 will not enter into and interfere with the second optical modulating part 23, it is possible to securely control the operating point.

The laser light is adjusted to a predetermined light intensity in the variable optical attenuating part 21, modulated to RZ (return-zero) light signals by the first optical modulating part 22 and the second optical modulating part 23, and outputted from the optical modulator. The outputted RZ light signals are inputted into an optical fiber for transmission via a lens.

Thus, in an optical modulator according to the embodiment, the variable optical attenuating part 21, the first optical modulating part 22, and the second optical modulating part 23 are formed on the same substrate 31. However, since optical waveguides 36-1 and 36-2 exclusively for leading out the leaking light and emissive light from the variable optical attenuating part 21 are formed, it is possible to release the leaking light and emissive light of the variable optical attenuating part 21 so as not to adversely influence the first optical modulating part 22 and the second optical modulating part 23. The optical waveguides 36-1 and 36-2 lead out the leaking light and emissive light from the first optical modulating part 22 so that it is also possible to lead out the leaking light and emissive light of the variable optical attenuating part 21 and the first optical modulating part 22 so as not to adversely influence the second optical modulating part 23. Further, since the leaking light and emissive light can be lead out, the optical receiving part 25 can receive the leaking light and emissive light from the second optical modulating part 23, whereby the signal control circuit 24 can optimally retain the operating point of the second optical coupling part 23.

### Numerical Example

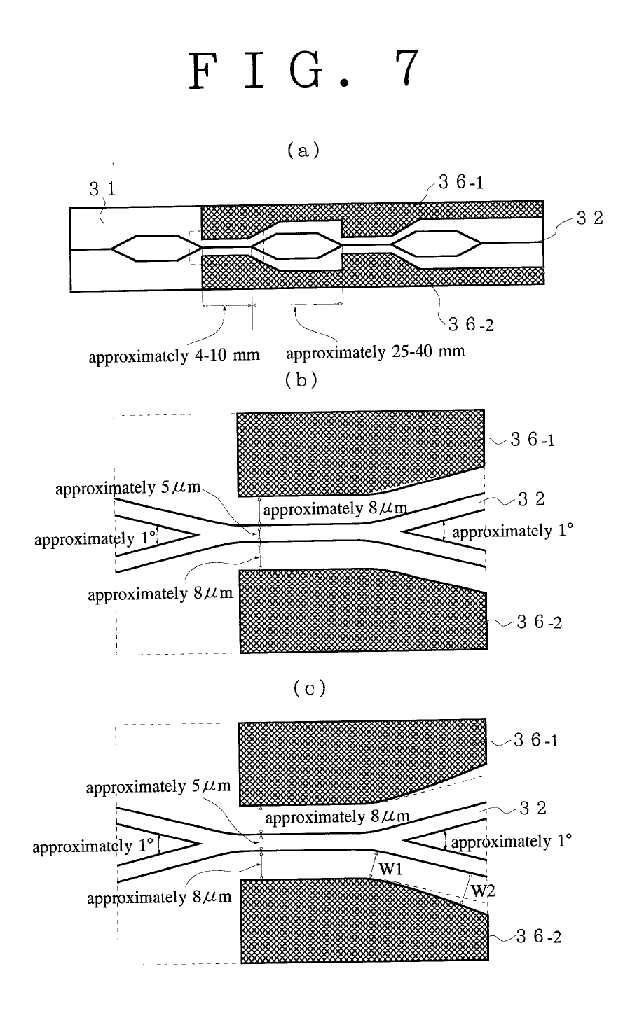

FIGS. 7 are a view showing the entire construction of an optical waveguide according to the invention and partially enlarged views showing a part from the Y-shaped coupling part R2 to the Y-shaped dropping part R1.

FIG. 7(a) is the same view as FIG. 2(c), which shows the substrate portion of the optical waveguide 32 that guides main light and the optical waveguide 36 that guides subsidiary light. FIG. 7(b) is a partially enlarged view of the portion b surrounded by broken lines in FIG. 7(a). FIG. 7(c) is also a partially enlarged view showing a case where the interval between the optical waveguide 32 and the optical waveguide 36 is gradually increased.

The dropping angle of the Y-shaped dropping part R1 and the coupling angle of the Y-shaped coupling part R2 are approximately one degree. The interval between the Y-shaped coupling part R2-1 of the variable optical attenuating part 21 and the Y-shaped dropping part R1-2 of the first optical modulating part 22 and the interval between the Y-shaped coupling part R2-2 of the first optical modulating part 22 and the Y-shaped dropping part R1-3 of the second optical modulating part 23 are both approximately four through ten mm. In each of the variable optical attenuating part 21, the first optical modulating part 22, and the second optical modulating part 23, the interval between the Y-shaped dropping part R1 and the Y-shaped coupling part R2 is approximately 25 through 40 mm. The mode field of the optical waveguide 32 is approximately 5 μm through 10 μm.

In such a case, the interval between the optical waveguide 32 and the optical waveguides 36-1 and 36-2 is designed to be approximately 8 μm in order to prevent coupling between these optical waveguides.

In this case, there has an effect that the output of the optical receiving part 25, which is used to control the operating point shifting of the second optical modulating part 23, is theoretically two times improved in terms of the signal-to-noise ratio.

Furthermore, in order to further suppress the coupling between the optical waveguide 32 and optical waveguides 36-1 and 36-2 as shown in FIG. 7(c), the optical waveguides 361 and 36-2 are not formed to be parallel to the optical waveguide 32, but they may be formed so that the interval therebetween is gradually increased (W1<W2).

### Pattern Example of the Optical Waveguide 36

Next, a description will be given of examples of other patterns of the optical waveguide 36.

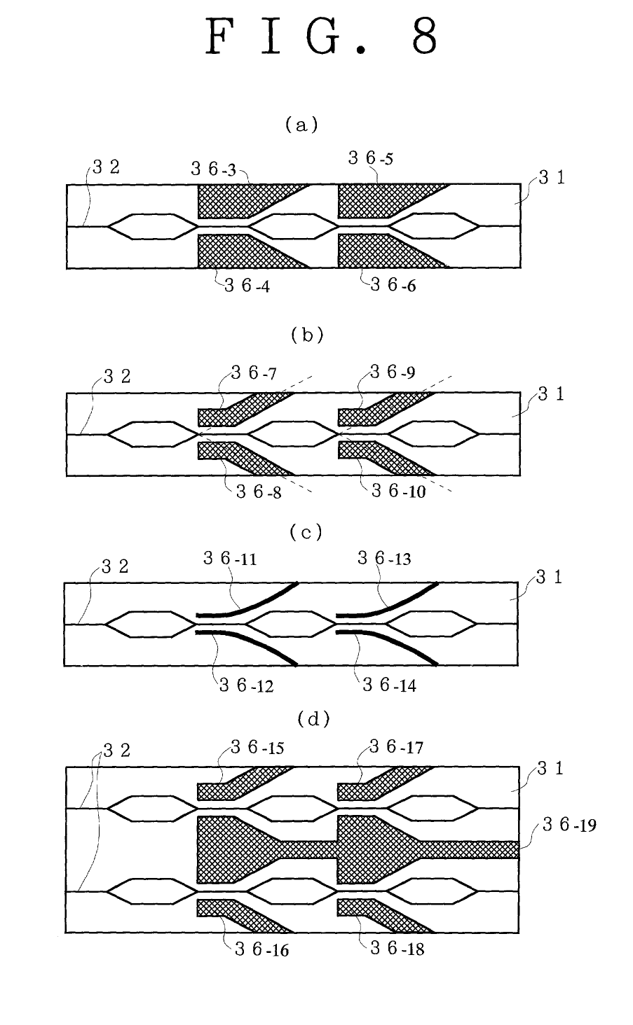

FIGS. 8 are views showing examples of other patterns of the optical waveguide according to the invention.

In the embodiment as shown in FIGS. 2, in the optical waveguide that guides leaking light and emissive light, an optical waveguide that guides leaking light and emissive light of the variable optical attenuating part 21, and an optical waveguide that guides leaking light and emissive light of the first optical modulating part 22 are formed integral with each other to form optical waveguides 36-1 and 36-2 having plane-like upper surfaces. However, as shown in FIG. 8(a), optical waveguides 36-3 and 36-4 that guide leaking light and emissive light of the variable optical attenuating part 21, and optical waveguides 36-5 and 36-6 that guide leaking light and emissive light of the first optical modulating part 22 may be separated from each other.

Moreover, it is understood through experimental observation that leaking light and emissive light from the Y-shaped coupling part R2 are propagated mainly on the extension line (shown by broken lines in FIG. 8(b)) of the Y-shaped portion in the intermediate optical waveguides 32c and 32d, therefore, the optical waveguides may be formed on the extension line as optical waveguides 36-7, 36-8, 36-9, and 36-10 with band-like upper surfaces, as shown in FIG. 8(b).

The optical waveguides according to the invention have only to prevent leaking light and emissive light from a preceding optical element from entering into a subsequent optical element and interfering with its main optical signal. Therefore, as shown in FIG. 8(c), in the first optical modulating part 22, optical waveguides 36-11, and 36-12 having linear upper surfaces are formed on both sides of the output optical waveguide 32d of the variable optical attenuating part 21 from the Y-shaped dropping part R2-1 so as to gradually separate from the input optical waveguide 32a, from the input optical waveguide 32a of the first optical modulating part 22 to the Y-shaped dropping part R1-2, whereby the leaking light and emissive light may be led out so as not to be mixed with or interfere with the main light signals of the first optical modulating part 22. Similarly, in the second optical modulating part 23, optical waveguides 36-13 and 36-14 having linear upper surfaces are formed on both sides of the output optical waveguide 32d of the first optical modulating part 22 from the Y-shaped dropping part R2-2 of the first optical modulating part 22 to so as to gradually separate from the input optical waveguide 32a of the second optical modulating part 23 toward the Y-shaped dropping pat R1-3, wherein the leaking light and emissive light may be led out so as not to be mixed with and interfere with the main light signals of the second optical modulating part 23.

Still further, when two optical modulators each consisting of a variable optical attenuating part 21, the first optical modulating part 22 and the second optical modulating part 23 for generating RZ signals, are formed in the form of array, optical waveguides 36-15 and 36-16 may be formed as shown in FIG. 8(d). If one end of the optical waveguide 36-19 cannot reach one side of the substrate 31 because of the existence of an optical element on its way, one side of the optical waveguide 36-19 is devised so as to reach the surface (at least one of the upper side and lower side) of the substrate 31, whereby the subsidiary light may be led out to the outside. In addition, in view of reliably releasing the subsidiary light to the outside, it is preferable to form a reflection mirror or a diffraction grating for making reflection, on the opposite of the surface where the subsidiary light is led out.

A description was given of the case where lithium niobate is used for a substrate in the embodiment, however, it is not limited to the case. Lithium niobate is a ferroelectric oxygen octahedral plane oxide having a large electrooptic effect, non-linear optic effect, and piezoelectric effect, and is also a compound applied for an optical modulator, an optical switch, a variable optical attenuator, an elastic surface wave filter, etc., and it is used as a substrate of an optical integrated circuit. As such a compound, for example, tantalum niobic acid may be used. A metal to be diffused may be selected to form an optical waveguide in compliance with the material.

In addition, for example, a substrate made of silicon (Si) and silicon oxide (SiO₂) may be used to form quartz-oriented glass optical waveguides on the substrate.

Various types of methods have been publicly known for production of the quartz-oriented glass optical waveguides. A brief description thereof will be given below.

First, a quartz-oriented glass film consisting of a lower cladding layer and a core layer is formed on a silicon substrate. As the formation method, a flame hydrolysis deposition method (FHD) in which, for example, SiCl₄, a material of quartz glass and GeCl₄ of a dopant are hydrolyzed in an oxyhydrogen flame to deposit glass of SiO₂-GeO₂, and a chemical vapor deposition method (CVD) in which a material SiH₄ flows around a substrate to deposit glass, etc., have been publicly known.

Second, a core layer is processed based on standard photolithography and micro-treatment such as RIE to form an optical waveguide.

Finally, the upper cladding layer is formed by FHD, CVD, etc.

Further, in the embodiment, a description was given of the case where an optical element formed on the substrate 31 is a variable optical attenuating part 21 and optical modulating parts 22 and 23. However, the optical element is not limited to such case. For example, it may be a variable wavelength selection optical filer (or acousto-optic tunable filter) utilizing an acousto-optic effect. The present invention is applicable to optical elements for controlling the state of light by applying a voltage to a ferroelectric material.

The invention is not limited to the above embodiments and various modifications may be made without departing from the spirit and the scope of the invention. Any improvement may be made in part or all of the components.

What is claimed is:

1. An optical circuit comprising:
a substrate having a plurality of optical elements formed;
a first optical waveguide formed on said substrate for guiding light to be outputted from said optical elements; and
a second optical waveguide formed on said substrate for guiding light which is emitted or leaking from said first optical waveguide.

2. The optical circuit according to claim 1, wherein at least one of said plurality of optical elements is a Mach-Zehnder type optical element.

3. The optical circuit according to claim 1, wherein at least one of said plurality of optical elements is a Mach-Zehnder interferometer type optical modulator.

4. The optical circuit according to claim 1, wherein at least two of said plurality of optical elements are connected in tandem.

5. The optical circuit according to claim 1, wherein said substrate is made of a ferroelectric material.

6. The optical circuit according to claim 1, wherein:
one of said plurality of optical elements is a first Mach-Zehnder type optical modulating part for applying a clock signal voltage at a predetermined cycle to an electrode for varying a refractive index of said first optical waveguide; and
one of said plurality of optical elements is a second Mach-Zehnder type optical modulating part connected in tandem with said first Mach-Zehnder type optical modulating part for applying a signal voltage modulated according to information to be transmitted, to said electrode.

7. The optical circuit according to claim 1, wherein said substrate is made of lithium niobate (LiNbO₃).

8. The optical circuit according to claim 7, wherein light outputted from said plurality of optical elements is inputted into said first Mach-Zehnder optical modulating part via a variable optical attenuating part capable of attenuating light intensity and varying an amount of attenuation.
